(19) United States
(12) Patent Application Publication
(10) Pub. No.: US 2004/0130451 A1
(43) Pub. Date: Jul. 8, 2004

(54) Locator system for a child

(76) Inventor: Edwina Cowell, Glenview, IL (US)

Correspondence Address: Welsh & Katz, Ltd., Jon P. Christensen, 22nd Floor, 120 South Riverside Plaza, Chicago, IL, 60606, US

(21) Appl. No.: 10/694,427

(22) Filed: Oct. 27, 2003

Related U.S. Application Data
(60) Provisional application No. 60/423,679, filed on Nov. 4, 2002.

(51) Int. Cl. G08B 23/00

(52) U.S. Cl. 340/573.4; 340/539.32

(57) ABSTRACT

A locator system is provided for use by a parent for locating a child. The locator system may include a radio frequency transmitter carried by the parent, a radio frequency receiver disposed within an article of clothing worn by the child and an annunciator connected to the radio frequency receiver that is activated by the radio frequency signal received through the radio frequency receiver.

### FIELD OF THE INVENTION

The field of the invention relates to locator devices and more particularly to a locator device for a child.

### BACKGROUND OF THE INVENTION

Every parent can understand the terror that a mother feels when her child is missing, even for a moment. Small children are energetic and curious by nature. They are distracted in an instant and easily drift away in all sorts of situations, from harmless to dangerous. Sometimes they hide, sometimes they go off in search of some new discovery and sometimes they just quietly wander away. Even the most attentive mother often finds herself frantically looking for her child, in the mall, at the toy store, the library or the zoo.

Further, in some environments such as a crowded mall, it is difficult to keep track of children. If a child is following a parent and is momentarily distracted, then the child may stop and the parent may keep walking. In such a case the parent and child may be easily separated. Further, in an attempt to find each other, the parent and child may walk in opposite directions.

While most instances of missing children are resolved without incident, there are also cases where abduction by a predatory adult may be involved. Predators will often verbally engage a small child and attempt to gain the child's trust. If enough time passes before the child is located or is noticed to be missing, the predator may be able to gain the child's trust and may follow the predator without protest.

In an effort to avoid losing their children, parents are often forced to fixate on and maintain physical contact with their children rather than think about other tasks immediately at hand. This can lead to frustration and to the inability of parents to accomplish even simple tasks. Because of the importance of child safety, a need exists for a means of locating children that is not based on physical contact.

### SUMMARY

A locator system is provided for use by a parent for locating a child. The locator system may include a radio frequency transmitter carried by the parent, a radio frequency receiver disposed within an article of clothing worn by the child and an annunciator connected to the radio frequency receiver that is activated by the radio frequency signal received through the radio frequency receiver.

### BRIEF DESCRIPTION OF THE DRAWINGS

FIG. 1 is a perspective view of the child locator system in accordance with an illustrated embodiment of the invention; and

FIG. 2 is a block diagram of the system of FIG. 1.

### DETAILED DESCRIPTION OF AN ILLUSTRATED EMBODIMENT

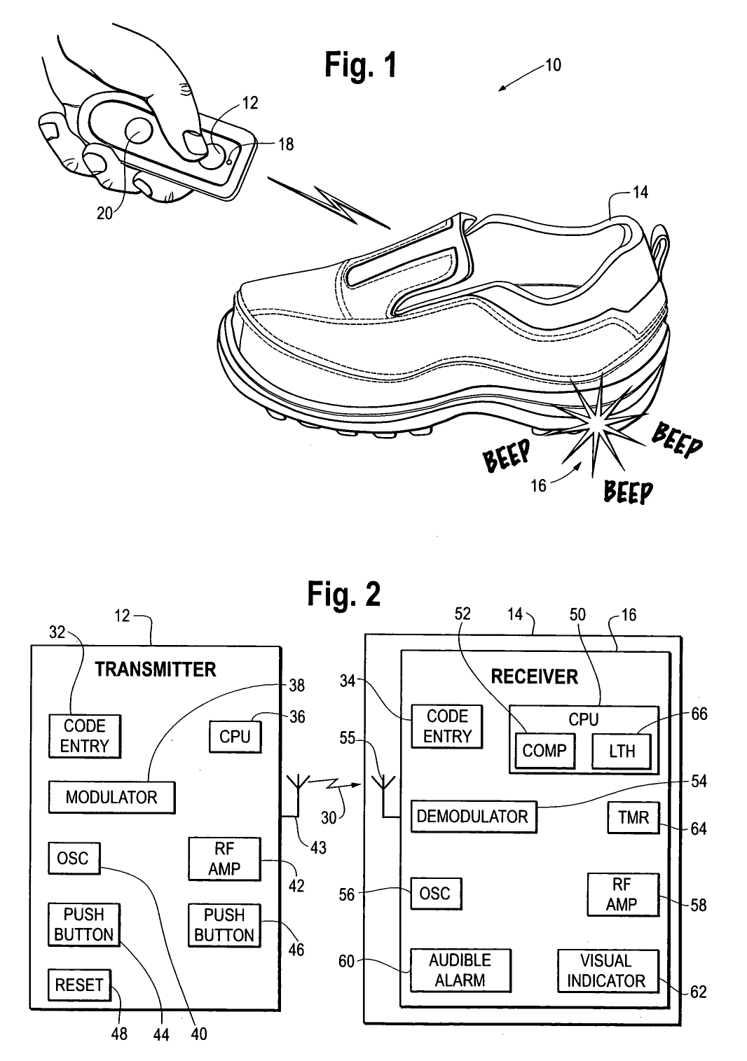

FIG. 1 depicts a child locator system 10 generally in accordance with an illustrated embodiment of the invention. FIG. 2 is a block diagram of the locator system 10 of FIG. 1. As shown, the child locator system 10 may include a transmitter 12 carried by a parent and a receiver 16 (with annunciator) that may be disposed within an article of clothing (e.g., a shoe) 14 of the child. While the receiver 16 could be disposed almost anywhere within the child's clothing, it has been found that the heel of the child's shoe is a particularly effective location because of the sound propagation characteristics provided by the outer surface of the shoe's heel. In alternate embodiments, the receiver may be attached to an outer surface of the shoe (e.g., attached to the shoelaces of the shoe 14.

The child locator system 10 may be activated by the parent at any time by pressing a locate pushbutton 18 on the transmitter 12. Activation of the locate pushbutton 18 causes the transmitter 12 to transmit an encoded activation signal 30 to the receiver 16 that, in turn causes the receiver 16 to emit a sensible signal (e.g., a relatively loud audible sound from an annunciator) that continues until the parent activates a reset button 20 on the transmitter 12. As used herein, an annunciator is a transducer that produces a signal that is detectable through the senses of a parent anywhere within the surroundings of the parent.

Where an audible alarm is used, the audible nature of the alarm may be continuous or intermittent. Where the alarm is intermittent, the alarm may be selected to be of a frequency and repetition rate that is different than cell phones and paging beepers to avoid confusing the locator sound with a phone or paging beeper.

Upon activating the locate pushbutton 18, the parent may then follow the sound to the child. In addition to, or alternatively, the receiver 16 may also provide a visual indication (e.g., a flashing light) that helps the parent locate the child in darkened areas. Where a flashing light is used, the flash rate may be adjusted to differentiate the locator light signal from prior art shoes that flash as a child walks. In this case, the flashing rate may be set to some rate (e.g., twice a second) that is clearly different than the flashing rate caused by walking.

In order to differentiate between radio frequency signals provided by the locator system 10 and those used by other systems, the system 10 may be provided with a set of code selection switches 32, 34. The code selection switches 32, 34 may be provided in the form of four independently set, 10-position switches that a parent may program with a unique code. The unique code may be incorporated into coded signals transmitted by the transmitter 12 to the receiver 14 and used by the receiver 14 to identify instructions from the transmitter 12.

The use of four switches with ten positions, each, allows for use of up to 10,000 possible codes and reduces the possibility of false alarms. In use, the code selector switches 32 in the transmitter 12 would be set to the same position as the switches 34 in the receiver 14.

In use, the transmitter 12 may be provided with a central processing unit (CPU) 36 that continually monitors a set of pushbuttons 44, 46, 48. Activation of the locate pushbutton 18 (44 in FIG. 2) may cause the CPU 36 to retrieve a code value from the code entry switches 32 and to compose an instruction associated with the pushbutton 44 that would, in turn, be transmitted to the receiver 16. The code value may be encoded by the CPU 36 using any appropriate encoding format (e.g., Huffman coding). Once encoded, the CPU 36 may transfer the instruction to a modulator 38 where the encoded code value may be modulated onto a carrier signal from an oscillator 40 using an appropriate modulation format (e.g., amplitude modulation (AM), frequency shift keying (FSK), frequency modulation (FM), quadrature amplitude modulation (QAM), spread spectrum modulation, etc.). The modulated signal may than be amplified within a radio frequency amplifier 42 and the amplified signal 30 transmitted through the antenna 43 to the receiver 14.

Within the receiver 16, signals received through an antenna 55 may be continuously amplified within an RF amplifier 58, downshifted to baseband using a local oscillator 56 and demodulated within a demodulator 54. A CPU 50 may retrieve a local code value from switches 34 and continuously compare the local code value with a code found within any received signals within a comparator 52. When a match is found, the CPU 50 may decode and execute any instruction received along with the code value. For example, if the decoded instruction is a locate signal, then the CPU 50 may activate the audible alarm 60. Alternatively, if the decoded instruction is a locate instruction for a visible alarm caused by activation of the second pushbutton 46, then the CPU 50 may activate the visual indicator 62. The CPU 50 may also use a timer 64 to control the on and off sequence of the visual alarm 62.

The decoded instruction may also be a reset signal cause by activation of the reset button 48. In the case of detection of the activation of the reset button, the CPU 50 may deactivate any alarms 60, 62 found to be active.

Once activated, a latch 66 within the CPU 50 would retain the indicators 60, 62 in an active state. The reset instruction may function to deactivate the indicators 60, 62 by deactivating the latch 66.

The use of an annunciator(s) 60, 62 allows a parent to find a child under virtually any circumstances. The availability of both audible and visual indicators 60, 62 allows a parent to select the indicator 60, 62 most appropriate to the circumstances. For example, in a darkened movie theater, a parent may simply activate the visual indicator 62 to locate the child without disturbing other patrons. Alternatively, in a crowed mall, the parent may activate the visual and audible indicators 60, 62 to locate the child based upon the parent's sense of sight or hearing.

A specific embodiment of a method and apparatus for locating a child has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A locator system used by a parent for locating a child comprising:
a radio frequency transmitter carried by the parent;
a radio frequency receiver disposed within an article of clothing worn by the child; and
an annunciator connected to the radio frequency receiver that is activated by the radio frequency signal received through the radio frequency receiver.

2. The locator system as in claim 1 wherein the annunciator further comprises an audible alarm.

3. The locator system as in claim 2 wherein the annunciator further comprises a visual indicator.

4. The locator system as in claim 3 further comprising a first pushbutton that activates the audible alarm and a second pushbutton that activates the visual indicator.

5. The locator system as in claim 1 wherein the visual indicator further comprises a light emitting diode.

6. The locator system as in claim 1 wherein the article of clothing further comprises a shoe.

7. The locator system as in claim 1 wherein the radio frequency transmitter further comprises a code selector on the transmitter and also on the receiver that allows the parent to select a unique code that activates the audible alarm.

8. The locator system as in claim 7 wherein the radio frequency transmitter further comprises a modulator that modulates a signal based upon a code entered through the code selector.

9. The locator system as in claim 8 wherein the radio frequency transmitter further comprises a processor that receives a code from the code selector and that sequentially modulates the modulator based upon the selected code.

10. The locator system as in claim 9 wherein the modulator further comprising an amplitude modulator that modulates an amplitude of a signal that is transmitted to the radio frequency receiver.

11. The locator system as in claim 9 wherein the modulator further comprising a frequency modulator that modulates a frequency of a signal that is transmitted to the radio frequency receiver.

12. The locator system as in claim 9 wherein the modulator further comprising a spread spectrum modulator that modulates a frequency of a signal that is transmitted to the radio frequency receiver.

13. A locator system used by a parent for locating a child that is activated by a transmitter carried by the parent, such locator system comprising:
a shoe to be worn by the child;
a radio frequency receiver connected to the shoe and activated by the transmitter carried by the parent; and
an annunciator connected to the radio frequency receiver that is activated by the radio frequency signal received through the radio frequency receiver.

14. The locator system as in claim 13 wherein the annunciator further comprises an audible alarm.

15. The locator system as in claim 14 wherein the annunciator further comprises a visual indicator.

16. The locator system as in claim 15 further comprising a first pushbutton located on the transmitter carried by the parent that activates the audible alarm and a second pushbutton on the transmitter that activates the visual indicator.

17. The locator system as in claim 13 wherein the visual indicator further comprises a light emitting diode.

19. The locator system as in claim 13 wherein the radio frequency receiver further comprises a code selector that allows the parent to select a unique code that activates the audible alarm.

20. The locator system as in claim 19 wherein the code selector further comprises a selector switch.
